(19) United States
(12) Patent Application Publication
(10) Pub. No.: US 2022/0244403 A1
(43) Pub. Date: Aug. 4, 2022

(54) METHOD AND APPARATUS FOR DISTRIBUTING HIGH PRECISION PREDICTED SATELLITE ORBITS AND CLOCKS DATA

(71) Applicant: RX NETWORKS INC., Vancouver (CA)

(72) Inventors: Vijaykumar BELLAD, Vancouver (CA); Thyagaraja MARATHE, Vancouver (CA); Yuansong CHEN, Vancouver (CA); Srinivas Chakrapani TANTRY, Vancouver (CA)

(21) Appl. No.: 17/590,658

(22) Filed: Feb. 1, 2022

Related U.S. Application Data
(60) Provisional application No. 63/145,313, filed on Feb. 3, 2021.

(51) Int. Cl. G01S 19/25; G01S 19/37; G01S 19/23

(52) U.S. Cl. CPC G01S 19/256; G01S 19/258; G01S 19/23; G01S 19/37

(57) ABSTRACT

A method of distributing satellite orbits and clocks data includes obtaining precise predicted satellite positions and precise predicted clocks at discrete time epochs, determining orbit corrections to broadcast ephemeris based on the precise predicted satellite positions and satellite positions computed using broadcast ephemeris from satellites, fitting the orbit corrections to an orbit correction model, determining clock corrections to broadcast ephemeris based on the precise predicted clocks and clocks computed using the broadcast ephemeris from satellites, fitting the clock corrections to a clock correction model, and disseminating the orbit correction model and clock correction models.

### CROSS REFERENCE TO RELATED APPLICATION

This application claims the benefit of priority of U.S. Provisional Patent Application No. 63/145,313 filed Feb. 3, 2021, which is hereby incorporated by reference in its entirety.

### TECHNICAL FIELD

The present disclosure relates to the prediction of satellite orbits and clocks data for use in high accuracy location determination for Global Navigation Satellite System (GNSS) positioning systems.

### BACKGROUND

Solutions to improve GNSS position fix accuracy continue to be sought as the number of services that rely on location grows. Accurate position fixes are particularly important when locating individuals in need of assistance but also add functionality and reliability to many location-based services.

GNSS receivers utilize satellite orbits & clocks data and atmospheric delay information along with range measurements to compute reasonably accurate user position. In a standard positioning method, also referred to as single point positioning, the accuracy achievable with standard broadcast data from GNSS satellites is about 5 meters. Accurate satellite orbits, clocks and signal propagation delay models or lumpsum range corrections are normally used by GNSS receivers for improved user position accuracy.

Differential positioning techniques are known to improve the user position accuracy by getting Differential GNSS (DGNSS) data from a nearby reference station with known coordinates. The DGNSS data provide the corrections to the range measurements made at the rover device in lump sum form. In other words, all the range error components, including satellite orbits and clocks errors, satellite hardware biases, atmospheric propagation effects, are bundled into one differential correction. These differential corrections are valid for a very limited interval such as one minute for sub-meter user position accuracy. Achieving and maintaining centimeter level accuracy using carrier phase range observations requires DGNSS data continuously with update intervals of a few seconds. Further, differential positioning requires a two-way communication between user device and a reference station.

Precise Point Positioning (PPP) is another high precision positioning method wherein precise satellite orbits and clocks are used at the receiver device by using individual corrections data also known as State Space Representation (SSR) corrections, obtained at the device through a network connection. In order to receive corrections from a network in real-time, the receiver devices requiring precise position are continuously connected to internet or via another communication channel. Typically, high precision correction generation servers estimate orbits, clocks, atmospheric delays and satellite bias corrections in real-time for dissemination over a network. These real-time satellite orbits and clocks corrections are not useful for high precision positioning beyond a few minutes from the time of applicability. Atmospheric corrections are normally valid for a relatively longer time, for example, in the range of 10 to 15 minutes.

### SUMMARY

The disclosed method of distributing high precision satellite orbits and clocks prediction data is highly beneficial to devices that do not have continuous network connectivity and/or devices that want to reduce data bandwidth but still require high accuracy location.

The present disclosure relates to distribution of one or both of precise satellite orbits and clocks prediction data for use in high precision GNSS receivers to replace or augment the real-time high precision corrections in satellite-based navigation systems. The precise orbits and clocks prediction and distribution significantly reduces the amount of data transferred over the network and provides accurate satellite orbits and clocks even during wireless network outage at client devices with GNSS receivers.

High precision positioning GNSS receivers using SSR corrections generally receive the corrections in real-time. The corrections are generated by a server estimating satellite orbits and clocks in real-time. The data is distributed in open standard formats periodically with update intervals from one second up to a minute. The validity of the corrections is not long enough and positioning accuracy at the receiver degrades in case the corrections are not received for more than a few minutes. Examples of the open standard correction formats include RTCM SSR, CSSR, SPARTN, etc.

One of the limitations of the existing high precision correction data dissemination methods is that the real-time orbits and clocks corrections are not valid for more than a few minutes impacting position accuracy of GNSS receivers in case of network outages. Further, continuous transmission of real-time corrections increases the amount of data transferred over wireless network.

In one aspect of the present invention, precise GNSS orbits and clocks are generated by using observations from a number of reference stations across the globe and the navigation data collected over a past period, e.g., a period of 24 hours. Precise satellite positions and clocks are generally estimated for a day in the past and then predicted at equally spaced epochs (e.g., 15 minutes) for a future period of about a day in a server. The estimation and prediction epochs are generally chosen to be 5 minutes or more for computational efficiency on the server. Accuracy of the predicted satellite positions degrade over time. Therefore, in the context of providing precise predicted orbits, the predictions are limited to a few hours up to a day. The predicted precise satellite positions at discrete epochs are generally converted to a continuous-time precise orbit model (e.g., Keplerian parameters) following physical models to obtain satellite positions at any given time. The predicted orbits are normally fit for multiple shorter duration fit intervals to retain the accuracy of the predicted precise orbits predictions.

Generally, orbit and clock parameters broadcast as part of ephemeris by GNSS satellites are valid for a few hours in the future. Predicted radial (deltaR), along-track (deltaA) and cross-track (deltaX) orbit correction components to broadcast satellite orbits are computed for the validity period of the broadcast ephemeris and a brief duration beyond as well for overlap until next set of ephemeris is available at the receiver. The multiple predicted orbit models of shorter fit intervals are used along with the satellite broadcast ephemeris in generating deltaR, deltaA and deltaX corrections within a broadcast ephemeris validity period for limiting orbit inaccuracy to 2 cm or lower. The predicted corrections are then fit to continuous-time models, e.g., 3^{rd} or 4^{th} order polynomials. The predicted correction models are transmitted from the server for use in GNSS receiver client devices. The corrections can be fit to n^{th} order polynomials for multiple shorter durations, e.g., 15 minutes, 30 minutes, 1-hour or 2-hour fit intervals in future.

Predicted clock corrections to broadcast satellite clocks are transmitted to high precision GNSS receivers as a model e.g. a polynomial (1^{st} order or 2^{nd} order) for the validity of the broadcast clocks duration (and extended overlap period as in the case of orbits).

According to an aspect of an embodiment, a method of distributing precise predicted satellite orbits and clocks data is provided. The method includes obtaining precise predicted satellite positions and precise predicted clocks at discrete time epochs, determining orbit corrections to broadcast ephemeris based on the precise predicted satellite positions and satellite positions computed using broadcast ephemeris from satellites, fitting the orbit corrections to an orbit correction model, determining clock corrections to broadcast ephemeris based on the precise predicted clocks and clocks computed using the broadcast ephemeris from satellites, fitting the clock corrections to a clock correction model, and disseminating the orbit correction model and clock correction model.

According to another aspect of an embodiment, a method is provided for obtaining precise satellite position and precise clocks at an electronic device. The method includes receiving one or more predicted orbit and clock correction models, generating radial, along-track, and cross-track correction components from a selected one of the orbit correction models at a discrete time epoch, converting the radial, along-track, and cross-track correction components to satellite position corrections in Cartesian co-ordinates, computing satellite positions and clocks using broadcast ephemeris from satellites, determining precise satellite positions based on the satellite position corrections in Cartesian co-ordinates and the computed satellite positions using broadcast ephemeris, obtaining the precise satellite position using the precise satellite position corrections, generating clock corrections based on a selected one of the clock correction models, determining precise clocks based on the clock corrections generated and the clocks computed using broadcast ephemeris, and obtaining precise clocks using the precise clock corrections.

According to another aspect of an embodiment, a method of distributing satellite orbits data is provided. The method includes obtaining precise predicted satellite positions at discrete time epochs, determining orbit corrections to broadcast ephemeris based on the precise predicted satellite positions and satellite positions computed using broadcast ephemeris from satellites, fitting the orbit corrections to orbit correction models, and disseminating the orbit correction models.

According to yet another aspect of an embodiment, a method of distributing satellite clocks data is provided. The method includes obtaining precise predicted clocks at discrete time epochs, determining clock corrections to broadcast ephemeris based on the precise predicted clocks and clocks computed using the broadcast ephemeris from satellites, fitting the clock corrections to clock correction models, and disseminating the clock correction models.

According to still another aspect of an embodiment, a method of distributing satellite orbits and clocks data is provided. The method includes determining precise predicted satellite positions and precise predicted clocks at discrete time epochs utilizing past precise satellite positions and precise satellite clocks, utilizing the precise satellite positions to create continuous-time orbit models, utilizing the precise predicted clocks to create continuous-time clock models, fitting the clock corrections to clock correction models, and disseminating the continuous-time orbit models and the continuous-time clock models.

According to another aspect of an embodiment, a method is provided for obtaining precise satellite positions and precise clocks at an electronic device. The method includes receiving precise predicted orbit and precise predicted clock models, determining precise satellite positions at an epoch of interest utilizing a selected one of the precise predicted orbit models, and determining precise satellite clocks at the epoch of interest utilizing a selected one of the precise predicted clock models.

### DRAWINGS

The following figures set forth examples in which like reference numerals denote like parts. The present disclosure is not limited to the examples illustrated in the accompanying figures.

FIG. 1 shows a system of distribution of predicted satellite orbit and clock corrections for precise user positioning, according to an embodiment;

FIG. 2 is a flowchart showing a method of predicting satellite orbits and clocks data, determining orbit and clock correction models to satellite broadcast ephemeris and dissemination of the correction models according to an aspect of an embodiment;

FIG. 3. shows example graphs of radial, along-track and cross-track correction components time series;

FIG. 4. shows an example of fit-intervals of satellite broadcast ephemeris, fit intervals of precise predicted orbit models, and fit intervals of precise orbit correction models of one of radial, along track and cross track corrections to broadcast ephemeris satellite positions in accordance with an aspect of an embodiment;

FIG. 5 is a flowchart showing a method of receiving and using predicted satellite orbits and clocks corrections data, according to another aspect of the embodiment of FIG. 2;

FIG. 6 is a flowchart showing a method of predicting and disseminating precise satellite orbits and clocks data, according to an aspect of another embodiment;

FIG. 7 is a flowchart showing a method of receiving and using precise predicted satellite orbits and clocks data, according to another aspect of the embodiment of FIG. 6.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. Unless explicitly stated, the methods described herein are not constrained to a particular order or sequence. Additionally, some of the described methods or elements thereof can occur or be performed at the same point in time. In other instances, well-known methods, procedures and components have not been described in detail so as not to obscure the examples described herein. Also, the description is not to be considered as limiting the scope of the examples described herein. In this specification orbits and clocks refer to satellite orbits and satellite clocks respectively unless otherwise mentioned. Also, precise satellite positions or precise satellite orbits refer to an accuracy better than that obtained using satellite broadcast ephemeris, e.g., accuracy of 5 cm in each vector component. Precise satellite clocks refer to an accuracy better than that obtained using satellite broadcast ephemeris, e.g., accuracy of 1 ns.

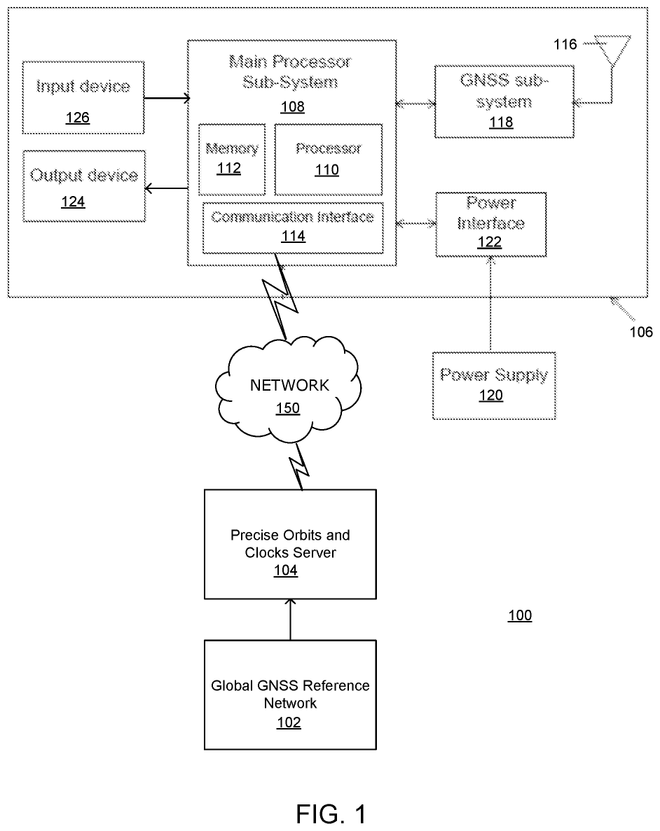

Referring to FIG. 1, an example of a system 100 for distribution of predicted orbits and clocks corrections for high precision GNSS receivers. The satellite systems for which the predicted corrections are transmitted may include GPS, GLONASS, Galileo, BeiDou, QZSS, NavIC, and is applicable for any other satellite-based navigation systems, including SBAS.

As illustrated in FIG. 1, a precise orbits and clocks estimation and prediction server 104 is in communication with a global GNSS reference station network 102. The global GNSS reference station network 102 includes several stations across the globe for observability of the satellites and typically has about 100 stations or more. The reference receivers at surveyed and known locations make range, range-rate and signal strength observations to signals on two or more frequencies of the GNSS satellites to precisely determine satellite orbits and clocks. Real-time data from the reference stations is used to generate precise orbits and clocks as well as precise predictions at the server 104.

The server 104 is in communication with the electronic device 106, also referred to herein as a client device, via a wireless connection, for example, through a network 150. As an example the network may be any wireless network that supports data communication. The electronic device 106 includes a main processor sub-system 108 that controls overall operation of thereof. The main processor sub-system 108 includes a processor 110, a memory 112 and a communication interface 114, which enables communication with server 104 via a wired or a wireless connection. An example of a main processor sub-system 108 is a Single Board Computer (SBC) with an Operating System (OS).

A GNSS receiver of the electronic device 106 includes a GNSS antenna 116 for receiving GNSS signals and a GNSS sub-system 118 in communication with the main processor sub-system 108 and the GNSS antenna 116. The GNSS sub-system 118 generates digitized GNSS data corresponding to the GNSS signals for further processing. The complete operation of GNSS receiver including user position estimation is performed by the GNSS sub-system 118. Alternatively, operations can be shared by the GNSS subsystem 118 and the main processor sub-system 108. Examples of a GNSS sub-system 118 include: a standalone GNSS receiver capable of generating a location estimate locally, an Assisted GNSS (A-GNSS) receiver that receives assistance data from another device to provide a location estimate, a Radio Frequency (RF) Front End (FE) in association with a Software Defined Radio (SDR) receiver at the electronic device 106 or distributed over one or more servers, including the server 104 in wireless communication with the electronic device 106.

The electronic device 106 is powered by a power supply 120, which communicates with the main processor sub-system 108 via a power interface 122. In an example, the power supply 120 is one or more batteries. The electronic device 106 includes an output device 124 in communication with the main processor sub-system 108. The output device 124 may be one or more of a display, a speaker and another type of output device, for example. The electronic device 106 includes an input device 126 in communication with the main processor sub-system 108 to receive user input, for example.

The electronic device 106 may be a Smartphone, tablet, portable computer, laptop computer, activity tracking device, beacon, router, drone, robot, Machine-to-machine (M2M) device or an in-vehicle navigation system, for example.

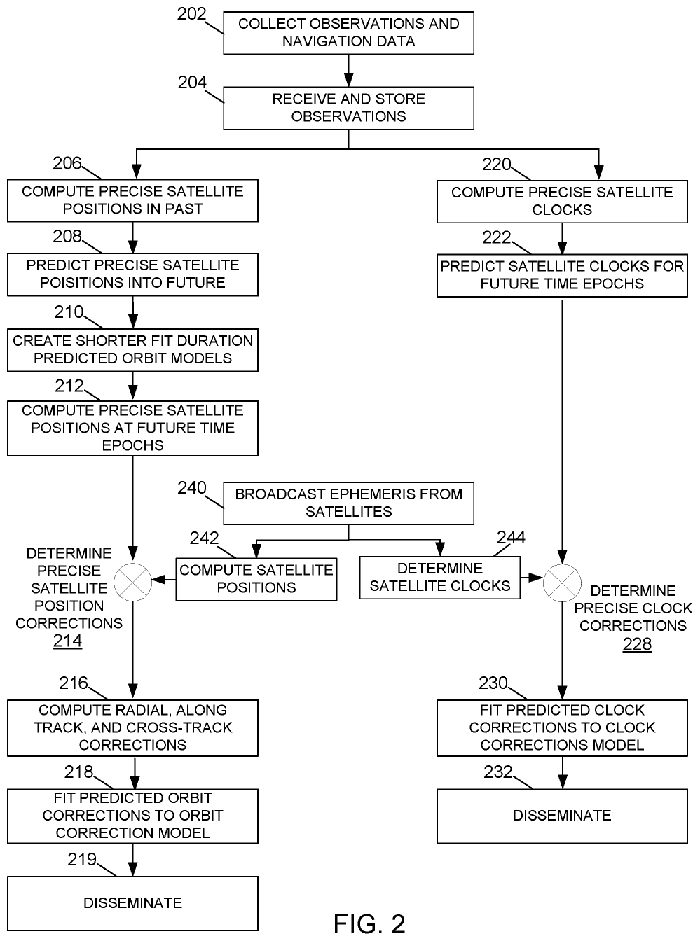

Reference is made to FIG. 2 to describe a method of distributing high precision predicted orbits and clocks data in accordance with an aspect of an embodiment. The method may include additional or fewer elements than shown and described and parts of the method may be performed in a different order than shown or described herein. The process shown in FIG. 2 may be carried out at the server 104.

As shown in the example of FIG. 1, the server 104 is in communication with the global GNSS reference stations network 102 and the server collects observations and navigation data continuously at 202. The server 104 stores the observations and navigation data for a period of time in the past at 204, e.g., 24-hour period, before estimating precise satellite positions and clocks data using the collected data.

The observations and navigation data from the reference stations is utilized to generate precise orbits and clocks as well as precise predictions at the server 104. The server 104 determines precise satellite positions for a satellite orbit arc in the past until the current time, utilizing range, range-rate and signal strength observations at several epochs in the past extending from a few hours to a few days along with broadcast navigation data, acceleration models, solar radiation pressure models, satellite body and antenna models, etc. Precise orbit determination is run a few times in a day to help generate predicted orbits more frequently and limit the inaccuracy in long-term prediction. The precise satellite positions are determined at 206 for the period over which the observations and navigation data was collected, e.g., 24 hours. The precise clocks are determined at 220 using real-time observations and navigation data.

Future satellite positions are predicted at 208 by the server 104 using orbital mechanics modeling all the forces acting on the satellites and with the current best estimates of satellite state vector and other parameters. The predicted satellite positions in the radial direction are sufficiently accurate for a few hours into the future, e.g., about 2 cm for up to 3 hours prediction. Therefore, the server 104 generates predicted satellite positions for a few hours, e.g., 24 hours period. The time interval of the predicted discrete satellite positions is based on the computational resources at the server 104. Generally, the time interval of the predicted discrete satellite positions is about 15 minutes. This process runs a few times a day using precise satellite positions data determined at 206 for one or more arcs in the past, e.g., eight times. The complete process of orbit determination and prediction can as well be run at different intervals, such as four, six, or 24 times in a day. Alternatively, this process of orbit determination and prediction is not run at the server 104. In this case the predicted discrete satellite positions are directly obtained by the server 104 from an external source at 208.

The predicted discrete satellite positions are used to create continuous-time orbit models at 210. Multiple continuous-time orbit models with shorter fit durations are created to achieve best fit accuracy with predicted discrete satellite positions. Precise satellite positions are computed at future time epochs using the continuous-time orbit models at 212. The time interval of these future time epochs is of the order of a few seconds, e.g., 5 seconds.

Alternatively, the predicted discrete satellite positions obtained at 208 are available at closely spaced time epochs, e.g., 5 seconds. These predicted discrete satellite positions themselves are used as the precise satellite positions at 212 without needing to create continuous-time orbit models.

The broadcast ephemeris of satellites obtained through reference network 102 or other means is received at 240. Satellite positions are computed using the broadcast ephemeris at 242 for the same time epochs of 212. Satellite position corrections are determined at 214 by computing the difference between the precise satellite positions determined at 212 and the satellite positions computed using broadcast ephemeris at 242.

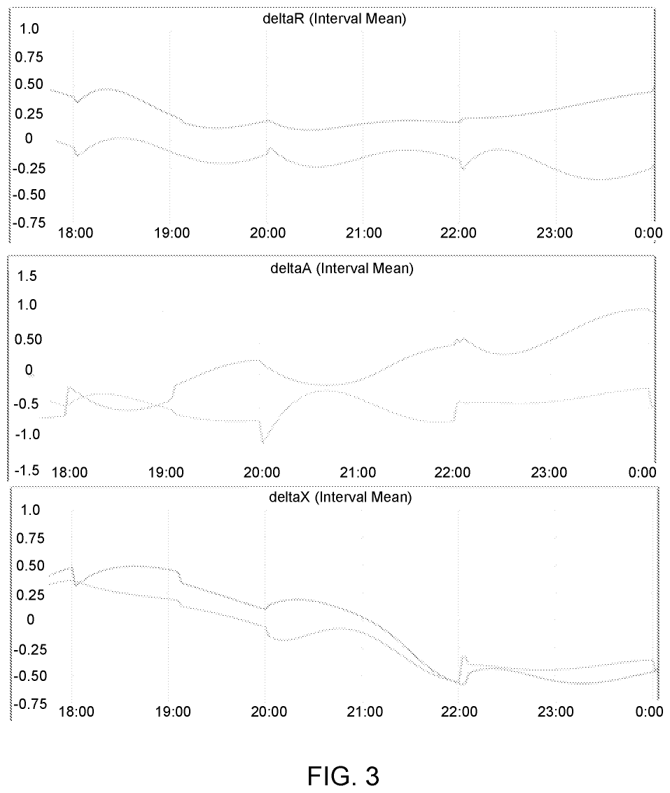

The satellite position corrections are first computed in cartesian coordinates at the future time epochs at 214. These satellite position corrections are then converted to radial, along-track and cross-track orbit correction components at 216. An example of radial, along-track and cross-track orbit correction components time series is shown in FIG. 3.

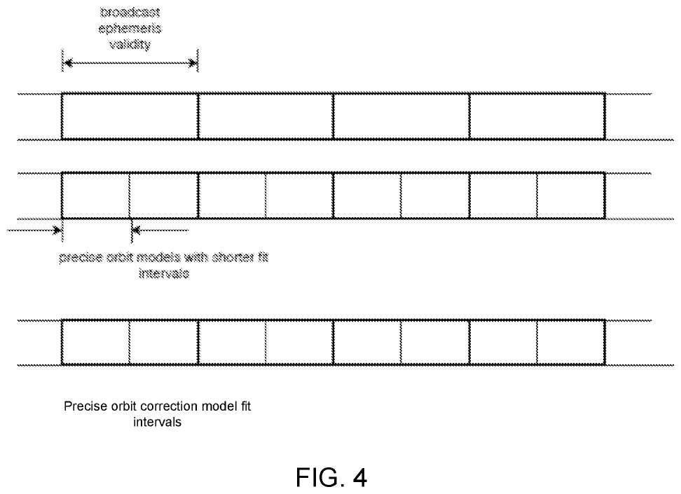

For each of the radial, along-track and cross-track orbit corrections at future time epochs a corresponding continuous-time orbit correction model is fit to represent the data at 218. The orbit correction model data fit intervals depend on the validity period of the satellite broadcast ephemeris and the fit interval of the precise continuous-time orbit model determined at 210. An example of the orbit correction model fit interval is shown in FIG. 4. The orbit correction model fit interval is the smaller of the precise predicted orbit model fit interval and satellite broadcast ephemeris validity period. A fourth or fifth order polynomial as an example model represents the orbit corrections with sufficient accuracy. Coefficients of polynomials are determined through a curve fitting method for each orbit correction component and for each satellite, e.g., Least Squares fitting. The orbit correction model may consist of one or more parameters, examples include model type and coefficients. These orbit correction model parameters are disseminated over a wired or wireless network at 219, e.g., polynomial model along with its coefficients. Each of the disseminated orbit correction models has a corresponding validity period in the future. The steps in 208, 210, 212, 240, 242, 214, 216 and 218 are repeated for each satellite of the GNSS constellation.

In an example, if any of the orbit correction components is smaller than a predetermined accuracy threshold, one or both of the steps of curve-fitting for that component at 218 and dissemination at 219 may be skipped. In another example, satellite position corrections in cartesian coordinates obtained at 214 may be directly fit to continuous-time orbit correction models without converting to radial, along-track and cross-track correction components, and disseminated.

Similarly, precise clocks are estimated at 220 and then predicted at 222 using a clock model determined based on the clock trend in the past at the server 104. The clock trend is determined using the estimated precise clocks for a period in the past. As an example the trend may be determined as a linear or quadratic model as the satellites use atomic standard clocks that have excellent long-term stability. Satellite clocks are predicted using the determined clock model for future time epochs at 222. Alternatively, this process of clock estimation and prediction is not run at the server 104. In this case the predicted clocks for future time epochs are directly obtained by the server 104 from an external source at 222.

Satellite clocks are computed using the broadcast ephemeris at 244 for the same time epochs of 222. Satellite clock corrections are determined at 228 by determining the difference between the precise clocks determined at 222 and satellite clocks computed using the broadcast ephemeris at 244.

A continuous-time clock correction model is fit to represent the satellite clock corrections data at future time epochs at 230. For example, a linear or quadratic polynomial model may be utilized to represent the satellite clock corrections with sufficient accuracy. Coefficients of the polynomials are determined through a curve fitting method, e.g., Least Squares fitting. The clock correction model may consist of one or more parameters, examples include model type and coefficients. The satellite clock correction model parameters are disseminated over a wired or wireless network at 232, e.g., polynomial model along with its coefficients. Each of the disseminated clock correction models has a corresponding validity period in the future. The steps in 222, 228, 240, 244, and 230 are repeated for each satellite of the GNSS constellation.

In addition to determining precise satellite orbits and clocks in batch mode every few hours, the server 104 also estimates the precise satellite position at 212 and clock at 222 in real-time using GNSS observations streamed from the reference network 102 continuously. Real-time clocks are utilized to predict satellite clocks more frequently with update rates of prediction as short as a few minutes, thus limiting the inaccuracy in predicted precise clocks. Additionally, updates to the prediction polynomials of individual satellites are sent in response to determining that real-time estimates are significantly different from the previously sent prediction polynomial or that the satellite vehicle becomes unhealthy. The satellite vehicle may be determined to be unhealthy based on one or both of the satellite health information published by GNSS constellations and real-time satellite maneuver detection by the server 104.

Relatively frequent updates to the predicted clocks will normally be utilized for clock correction models compared to orbit correction models as the clock correction models generally do not remain valid for the same duration as the orbit correction models.

Further, some satellites may have more updates to clock correction predictions relative to others depending on the short-term stability of each satellite. Further, some satellites may have clock correction models with a longer validity period compared to the clock correction model validity periods of other satellites.

In the aspect described above with reference to FIG. 2, the server 104 determines and sends corrections to satellites broadcast orbits and clocks in the form of continuous-time models for each satellite of the GNSS constellation to the electronic device 106.

A minimum payload “keep alive” message may be sent at periodic intervals in the time between dissemination of the orbit correction models and clock correction models to let the client devices, which includes the electronic device 106, know that there are no new updates, but the client devices are still connected to the service.

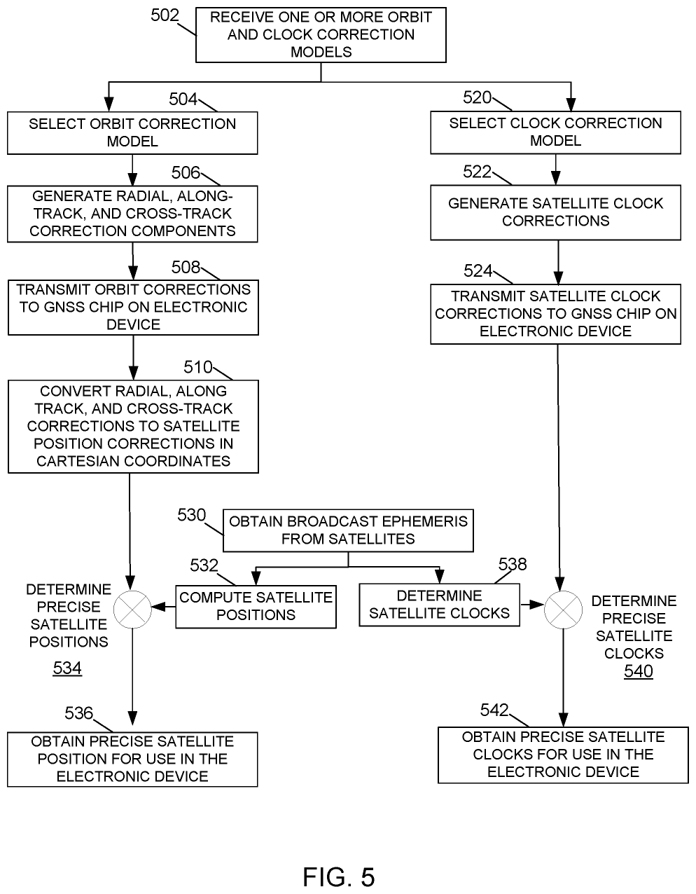

Referring now to FIG. 5, another aspect of an embodiment is described. FIG. 5 shows a flowchart illustrating a method of determining precise satellite positions and clocks at the electronic device 106 using the orbits and clocks corrections models transmitted by the server 104 and satellites broadcast ephemeris obtained at the electronic device 106. The method may include additional or fewer elements than shown and described and parts of the method may be performed in a different order than shown or described herein.

The orbit and clock correction models disseminated by the server 104 are received over a wired or wireless network at the electronic device 106 at 502. The appropriate orbit correction model among the received orbit correction models is chosen for generating the orbit corrections based on epoch of interest and validity period of the models at 504. Utilizing software executed by the processor 110 of the main processor subsystem 108, the orbit correction model is utilized to determine radial, along track and cross track orbit corrections at the epochs of interest at 506.

Similarly, the appropriate clock correction model among the received satellite clock correction models is chosen for generating the satellite clock corrections based on the epoch of interest and validity period of the models at 520. Utilizing software executed by the processor 110 of the main processor subsystem 108, the clock correction model is utilized to determine satellite clock corrections at the epochs of interest at 522.

In this example, orbit corrections computed for the epoch of interest are converted to standard real-time correction format (e.g., RTCM SSR, CSSR, etc.) and, at 508, are provided to the GNSS sub-system 118 on the electronic device 106. Similarly, clock corrections are provided at 524 to the GNSS subsystem 118 on the electronic device 106. In this example, the GNSS sub-system 118 is a standard precise positioning GNSS receiver that utilizes the corrections in the standard real-time correction format. Alternatively, the orbit and clock correction models received at 502 at the electronic device 106 are directly ingested into the GNSS sub-system 118. The GNSS sub-system determines radial, along-track and cross-track corrections, and clock corrections at the epochs of interest using the correction models.

The radial, along-track and cross-track orbit corrections are converted to satellite position corrections in Cartesian coordinates at 510.

The broadcast ephemeris from satellites is received at the electronic device 106 at 530. The broadcast ephemeris is either obtained from satellite signals received through GNSS antenna 116 by decoding navigation message data or obtained through data assistance over a wired or wireless network, such as the network 150.

Satellite positions are computed at epochs of interest at 532 using the broadcast ephemeris from the satellites. Precise satellite positions at epochs of interest are determined at 534 by applying the satellite position corrections in Cartesian coordinates from 510 to the satellite positions computed using the broadcast ephemeris at 532.

Precise satellite positions are then obtained at 536 for use in the electronic device 106.

Similarly, the satellite clocks are determined at the epochs of interest at 538 using the broadcast ephemeris. Precise satellite clocks are determined at 540 by applying the satellite clock corrections from 524 to the satellite clocks determined using the broadcast ephemeris at 538. The precise satellite clocks are obtained at 542 for use in the electronic device 106.

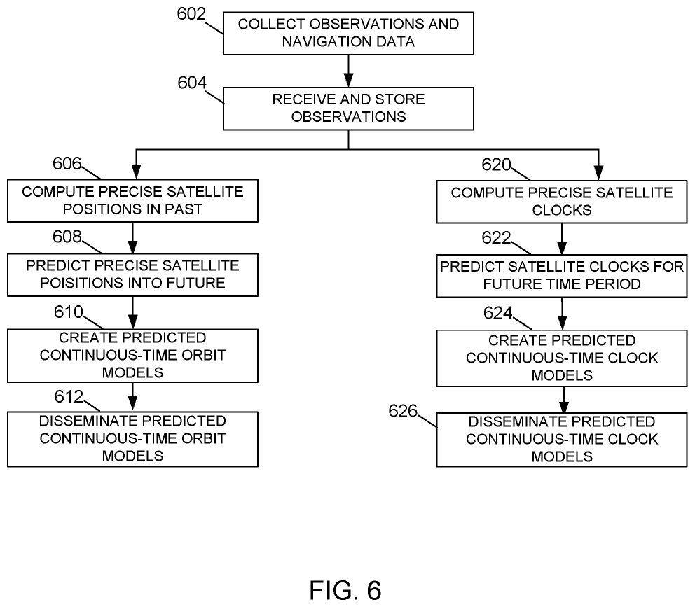

Reference is made to FIG. 6 to describe a method of distributing high precision predicted satellite orbits and clocks data in accordance with an aspect of another embodiment. The method may include additional or fewer elements than shown and described and parts of the method may be performed in a different order than shown or described herein. Many elements of the method are similar to those described above with reference to FIG. 2. In the present embodiment, however, the precise orbits and clocks models themselves are disseminated from the server 104 instead of the orbit and clock correction models.

As with the embodiment shown in FIG. 2, the server 104 is in communication with the global GNSS reference stations network 100 and the server collects observations and navigation data continuously at 602. The server 104 stores the observations and navigation data for a period of time in the past at 604, e.g., 24-hour period, before estimating precise satellite positions and clocks data using the collected data.

The observations and navigation data from the reference stations is utilized to generate precise orbits and clocks as well as precise predictions at the server 104 similar to the processes described with reference to FIG. 2. The precise satellite positions are determined at 606 for the period over which the observations and navigation data was collected, e.g., 24 hours. The precise clocks are determined at 620 using real-time observations and navigation data.

Future precise satellite positions are predicted at 608 using orbital mechanics modeling all the forces acting on the satellites and with the current best estimates of satellite state vector and other parameters. The predicted satellite positions in the radial direction are sufficiently accurate for a few hours into the future, e.g., about 2 cm for up to 3 hours prediction. Therefore, the server 104 generates predicted satellite positions a few times a day, e.g., eight times in a day, i.e., once every three hours using precise satellite positions data determined at 606 for one or more arcs in the past. The complete process of orbits determination and prediction can as well be run at different intervals, such as four, six, or 24 times in a day. The predicted discrete satellite positions are used to create continuous-time orbit models at 610. Multiple continuous-time orbit models with shorter fit durations are created to achieve best fit accuracy with predicted discrete satellite positions. In the present example, the predicted continuous-time orbit model is directly disseminated over a wired or wireless network at 612. The processes described and shown in 608, and 610 are repeated for each satellite of the GNSS constellation.

Similarly, precise clocks are predicted at 622 using a clock model determined based on the clock trend in the past. The clock trend is determined using estimated clocks data for a period in the past. Normally, the trend is determined as a linear or quadratic model as the satellites use atomic standard clocks that have excellent long-term stability. The predicted precise clocks are used to create continuous-time clock models at 624. Multiple clock models with shorter fit durations are created. In the present example, the predicted satellite clocks model is directly disseminated over a wired or wireless network at 626. The processes described and shown in 622 and 624 are repeated for each satellite of the GNSS constellation.

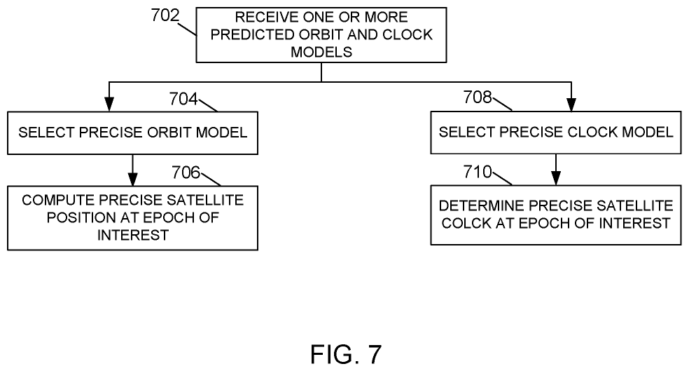

Referring now to FIG. 7, another aspect of an embodiment is described. FIG. 7 shows a flowchart illustrating a method of determining precise satellite positions and clocks at the electronic device 106. The method may include additional or fewer elements than shown and described and parts of the method may be performed in a different order than shown or described herein.

In the present embodiment, rather than receiving the orbit and clock correction models at the electronic device 106, precise orbit and clock models themselves are received by the electronic device 106 at 702. The appropriate precise orbit model among the received orbit models is chosen based on the epoch of interest and validity period of the models at 704 Precise satellite positions are then determined at the epoch of interest at 706. This process may be carried out by a software on the Main processor sub-system 108 or the GNSS sub-system 118.

The appropriate clock model among the received clock models is chosen based on the epoch of interest and validity period of the clock models at 708. Precise satellite clocks are then determined at the epoch of interest 710. This process can be carried out by a software on the Main processor sub-system 108 or the GNSS sub-system 118.

In accordance with another aspect of an embodiment, the electronic device 106 receives real-time orbit and clock corrections e.g., RTCM SSR corrections, in addition to the predicted orbits and clocks correction models from the server 104. The real-time orbits and clocks corrections can be received from the server 104 or another source. During normal operation the electronic device 106 applies the real-time corrections to the satellite positions and clocks computed using broadcast ephemeris to obtain precise satellite positions and clocks. However, in case of network outages the electronic device 106 is operable to instead utilize the orbit and clock corrections models to generate satellite positions and clocks corrections. These predicted satellite positions and clocks corrections are applied to the satellite positions and clocks computed using broadcast ephemeris to obtain precise satellite positions and clocks. Further, the electronic device 106 may make the decision to either receive and use the real-time corrections or receive and use the predicted orbit and clock correction models, depending on one or both of the bandwidth and power constraints of the electronic device 106 at a given time.

Utilizing the presently disclosed methods, data transmission costs and associated requirements may be reduced at the electronic device 106. In addition, electronic devices that do not have continuous network connectivity may still compute precise satellite positions and clocks for use at the electronic device 106.

Specific examples have been shown and described herein. However, modifications and variations may occur to those skilled in the art. All such modifications and variations are believed to be within the scope and sphere of the present disclosure.

1. A method of distributing precise predicted satellite orbits and clocks data, the method comprising:
obtaining precise predicted satellite positions and precise predicted clocks at discrete time epochs;
determining orbit corrections to broadcast ephemeris based on the precise predicted satellite positions and satellite positions computed using broadcast ephemeris from satellites;
fitting the orbit corrections to an orbit correction model;
determining clock corrections to broadcast ephemeris based on the precise predicted clocks and clocks computed using the broadcast ephemeris from satellites;
fitting the clock corrections to a clock correction model; and
disseminating the orbit correction model and clock correction model.

2. The method according to claim 1, comprising repeating obtaining, determining orbit corrections, fitting the orbit corrections, determining clock corrections, fitting the clock corrections, and disseminating are repeated for each of a plurality of satellites.

3. The method according to claim 1, wherein the orbit correction model comprises an nth order polynomial.

4. The method according to claim 1, wherein the clock correction model comprises a 1^{st} or 2^{nd} order polynomial for a validity of the broadcast clocks duration.

5. The method according to claim 1, comprising determining a difference between satellite positions and clocks estimates and satellite positions and clocks computed at those epochs using previously sent correction models.

6. The method according to claim 5, wherein disseminating the orbit correction models and clock correction models is in response to determining that the difference exceeds a threshold difference.

7. The method according to claim 5, wherein disseminating the orbit correction models and clock correction models is in response to an identified change in satellite health status.

8. The method according to claim 1, wherein the clock correction model for a first satellite is valid for a different period of time compared to the clock correction model for a second satellite.

9. The method according to claim 1, wherein a set of the orbit correction models and clock correction models are sent for a validity period.

10. The method according to claim 1, wherein the orbit correction model and clock correction model are sent for a future validity period along with real-time orbits and clocks corrections.

11. The method according to claim 1, wherein determining orbit corrections to broadcast ephemeris comprises computing satellite position differences in Cartesian coordinates and converting to radial, along-track, and cross-track components.

12. The method according to claim 1, wherein obtaining precise predicted satellite positions and precise predicted clocks at discrete time epochs comprises:
utilizing observations and navigation data received at a server to compute satellite positions over a previous time period and to compute satellite clocks in real time;
predicting satellite positions at discrete time epochs for a first future time period utilizing the satellite positions over the previous time period;
predicting satellite clocks at discrete time epochs for a second future time period utilizing the computed satellite clocks;
creating one or more predicted orbit models using the predicted satellite positions and having an orbit fit duration of less than or equal to the first future time period;
creating one or more predicted clock models using the predicted satellite clocks having a clock fit duration of less than or equal to the second future time period; utilizing the predicted orbit models and the predicted clock models, determining satellite positions at regular intervals for each orbit fit duration and determining clocks at regular intervals for each clock fit duration.

13. The method according to claim 1, wherein the precise predicted satellite positions and precise predicted clocks at discrete time epochs are received from an external source.

14. A method of obtaining precise satellite positions and precise clocks at an electronic device, the method comprising:
receiving one or more predicted orbit and clock correction models;
generating radial, along-track, and cross-track correction components from a selected one of the orbit correction models at a discrete time epoch;
converting the radial, along-track, and cross-track correction components to satellite position corrections in Cartesian co-ordinates;
computing satellite positions and clocks using broadcast ephemeris from satellites;
determining precise satellite positions by applying the satellite position corrections in Cartesian co-ordinates to the satellite positions computed using broadcast ephemeris;
generating clock corrections based on a selected one of the clock correction models; and
determining precise clocks by applying the clock corrections generated to the clocks computed using broadcast ephemeris.

15. The method according to claim 14, comprising selecting the one of the orbit correction models based on an epoch of interest and a validity period of the one of the orbit correction models.

16. The method according to claim 15, comprising selecting the one of the clock correction models based on the epoch of interest and a validity period of the one of the clock correction models.

17. The method according to claim 16, wherein computing satellite positions and clocks using broadcast ephemeris comprises computing the satellite positions and clocks at the epochs of interest.
